(19) United States
(12) Patent Application Publication
(10) Pub. No.: US 2025/0208313 A1
(43) Pub. Date: Jun. 26, 2025

(54) OPTICAL GRAVIMETER BASED ON FABRY-PEROT INTERFEROMETERS WITH FREQUENCY READING

(71) Applicants: PETRÓLEO BRASILEIRO S.A. – PETROBRAS, Rio de Janeiro (BR); UNIVERSIDADE FEDERAL DO RIO DE JANEIRO – UFRJ, Rio de Janeiro (BR)

(72) Inventor: Cláudio Lenz CESAR, Rio de Janeiro (BR)

(21) Appl. No.: 18/985,682

(22) Filed: Dec. 18, 2024

(30) Foreign Application Priority Data
Dec. 26, 2023 (BR) 1020230274099

(51) Int. Cl. G01V 7/04; G01J 3/02; G01J 3/26

(52) U.S. Cl. CPC G01V 7/04; G01J 3/021; G01J 3/0218; G01J 3/26; G01J 2003/262

(57) ABSTRACT

Embodiments of the equipment described herein uses lasers stabilized in the resonant optical cavities of Fabry-Perot Interferometers (FPIs), with at least one reference interferometer, in order to cancel the effects of atmospheric variation in the measurement of the variation of the gravitational acceleration. In addition, the radio frequency used in the modulators, or the frequency beat of the independent lasers, allows the measurement of the variation of “g” directly in the variable “frequency”, which allows high-precision measurements due to the existence of accurate clocks in counters/frequency meters. In short, the gravimeter comprises a high-finesse Fabry-Perot interferometer-based sensor with fast reading time, does not require high vacuum in the chamber thereof, can be operated in motion and can be subjected to very high pressures, without an extra encapsulation, and requires low electrical power for operation, and makes gravity measurements directly in frequency.

### FIELD OF THE DISCLOSURE

The present disclosure pertains to the field of gravitational mapping to provide auxiliary maps in the prospecting of oil & gas fields, aquifers, mineral reserves, and other natural geological or geographical features constructed by humans or animals. In a stationary application of the present disclosure, a plurality of gravimeters can monitor temporal variations of aquifers, reservoirs, oil and gas fields, Earth tides, seismic waves. In another application, a network of these sensors can be taken relatively close to wells for real-time and long-term monitoring of oil and gas extraction or liquid injection.

### Backgrounds of the Disclosure

Absolute gravimeters use a falling cube mirror, as reported in Niebauer et al. (T. M. Niebauer, G. S. Sasagawa, J. E. Faller, R. Hilt, F. Klopping. A new generation of absolute gravimeters. Metrologia 32, 159-180. 1995), in a configuration of Mach-Zehnder (or Michelson) interferometer interrogated by or free fall of atoms in an atomic stabilized lasers interferometer interrogated by stabilized lasers, according to the constructions indicated in Victoria et al. and Peters et al. (Victoria Xu, Matt Jaffe, Cristian D. Panda, Sofus L. Kristensen, Logan W. Clark, and Holger Müller, Probing gravity by holding atoms for 20 seconds, Science 366:745. 2019; Peters, A., Chung, K. Y., & Chu, S. High-precision gravity measurements using atom interferometry. Metrologia, 38 (1): 25. 2001). These gravimeters represent the main state of the art in absolute gravimetry measurement. They are sensitive and slow instruments, with a measurement cycle in seconds. They require sophisticated assembly, ultra-high vacuum, temperature control, and lasers stabilized to frequency standards such as atomic clocks, and long measurement preparation time for vertical adjustment.

Relative gravimeters exist using various technologies, such as “mass-spring” gravimeters as disclosed in Niebauer, Schilling (Niebauer, T. Gravimetric methods-Absolute and relative gravity meter: Instruments concepts and implementation. In Treatise on Geophysics. 37-57, 2015. Amsterdam: Elsevier.; Schilling, M., & Gitlein, 0. Accuracy estimation of the IfE gravimeters Micro-g LaCoste gPhone-98 and ZLS Burris Gravity Meter B-64. In C. Rizos & P. Willis (Eds.), IAG 150 Years. 143:249-256, 2015), those using superconductors as disclosed in Goodkind (J. M. Goodkind, The superconducting gravimeter. Rev. Sci. Instrum. 70:4131-4152, 1999), which are highly sensitive but require cryogenic temperatures, and compact ones such as MEMS-type devices, such as that disclosed in Middlemiss et al. (R. P. Middlemiss, A. Samarelli, D. J. Paul, J. Hough, S. Rowan, G. D. Hammond, Measurement of the Earth tides with a MEMS gravimeter. Nature 531:614-617, (2016) and further Fabry-Perot interferometers in a quasi-etalon regime (low finesse) and suitable as accelerometers (Feng Zhou, Yiliang Bao, Ramgopal Madugani, David A. Long, Jason J. Gorman, and Thomas W. LeBrun, Broadband thermos-mechanically limited sensing with an optomechanical accelerometer. Optica 8:350-356. 2021) and with limited sensitivity and no guarantee of long-term stability.

Fabry-Perot interferometers (FPIs) usually comprise an optical cavity with two high-reflectivity mirrors aligned face-to-face and recirculate the photons along their axis. They are optical elements that are extremely sensitive to the distance between their mirrors. If the reflectivity of the mirrors is high, the photons are recirculated for many round trips in the resonant cavity, which results in a parameter called “Finesse” with a high value.

The use of special spacers between the mirrors with ultra-low coefficients of thermal expansion or the use of sapphire at low temperatures, both with high-reflectivity optical mirrors optically contacted to these substrates in special geometries placed under high vacuum and under temperature control, form the basis of the Fabry-Perot Reference Optical Cavities, in which most ultra-stable lasers are locked.

That is, virtually every high-precision laser measurement (beyond parts in 10¹², now reaching beyond parts in 10¹⁸) involves one of these optical reference cavities. Examples of following this pattern include the experiment of a work for hydrogen laser spectroscopy at 400 μK in a magnetic trap as reported in Cesar et al. (Claudio L. Cesar, Dale G. Fried, Thomas C. Killian, Adam D. Polcyn, Jon C. Sandberg, Ite A. Yu, Thomas J. Greytak, Daniel Kleppner, John M. Doyle. Two-Photon Spectroscopy of Trapped Atomic Hydrogen. Phys. Rev. Lett. 77:255, 1996), as well as the recent measurement of an identical transition made in a study reported in Ahmadi et al. (Ahmadi, M., Alves, B. X. R., Baker, C. J. et al. [ALPHA Collab.], Characterization of the 1S-2S transition in antihydrogen. Nature 557:71-75, 2018), but now in antihydrogen.

In the initial proposal for the LIGO gravitational-wave meter and its recent success as reported in Abbott et al. (B. P. Abbott et al. LIGO Scientific Collaboration and Virgo Collaboration), Observation of Gravitational Waves from a Binary Black Hole Merger, Phys. Rev. Lett. 116:061102, 2016), the sensor element for the variation in space caused by the gravitational wave is composed of a Michelson interferometer in which, in each arm, there is a Fabry-Perot interferometer. While common experiments use Reference Cavities that are stable at small fractions of Angstroms (i.e., fractions of the size of an atom), the LIGO experiment can reach fractions of the size of a proton (atomic nucleus).

Considering the high sensitivity of the Fabry-Perot interferometer (FPI), some studies have considered mounting it in a special vertical configuration and making it sensitive to gravitational effects, as can be seen in Eduardo Müller dos Santos' Master's dissertation (Eduardo Müller dos Santos, CONSTRUçÃO DE UM NOVO SENSOR GRAVITACIONAL ÓPTICO POR FABRY-PEROT (CONSTRUCTION OF A NEW OPTICAL GRAVITATIONAL SENSOR BY FABRY-PEROT), Master's Dissertation supervised by Cláudio Lenz Cesar, UFRJ, April 2007). The approach was to build a Fabry-Perot interferometer with one of the mirrors, coupled to a mass, mounted in a tube with restricted displacement along its vertical axis (which coincides with the axis of the gravimeter), which is obtained through two vertically displaced membranes forming a “spring”.

The use of two or more membranes provides an essentially axial sensor, that is, a “spring” that is very rigid in the transverse direction, but sensitive in the axial direction. However, the initial approach did not provide for: measurement of “g” directly in frequency, which would allow high-precision measurements thanks to the existence of stable clocks; insensitivity to temperature and local atmosphere resulting in short temporal stability; a rapid calibration technique in relation to the local “g”; the ability to self-calibrate in relation to the direction of the local gravitational axis; the ability to subject the sensor to extreme pressures such as at the ocean floor.

In this way, the object of this disclosure is to build a non-absolute gravimeter-robust, sensitive, stable, compact, and transportable, and with a high interrogation rate from laser—locked Fabry-Perot optical interferometers (FPI) with direct frequency measurement. The gravimeter is dual, incorporating a sensor FPI and a reference FPI for temporal stability of the measurement. The gravimeter is calibratable against the local acceleration of gravity “g”—by a rotation system—or against an absolute standard. The gravimeter can be built in a triple configuration, allowing a vector measurement of \vec{g} and consequently self-adjustment in terms of orientation in relation to the local \vec{g} axis. The gravimeter sensor can be built in a chamber with internal and external pressure equalization, allowing large pressure variations, that is, to be submerged at great depths.

### STATE OF THE ART

The search for the history of the disclosure in question led to some documents that disclose matters within the technological field of the present disclosure; however, in these documents, there were still identified one or more of the above mentioned technical problems.

RU2193786 is part of the field of measurement of absolute values of free fall acceleration from a ballistic laser gravimeter that has a vacuum chamber, catapult, tested mass with corner optical reflector, laser displacement interferometer, horizontal pendulum-type vibration protector with spring suspension and reference corner optical reflector of the interferometer installed at the center of gravity of the pendulum.

In addition, in RU2193786, the corner optical reflector of the interferometer is mounted close to the articulated support to form a second information measurement channel. The influence of the seismic vibrations on the measurement result of free fall acceleration is excluded by inputting corrections for the difference in readings of the two channels with due account of the correlation communication between the same, resulting in the effect of greater measurement accuracy under seismic vibration conditions.

In the aforementioned Russian patent document, the gravimeter is based on a (absolute) free-falling cube mirror (mass) measured by a (stabilized) monochromatic laser Michelson interferometer. The addition of an extra mechanical system with a spring and a shock absorber system aims at eliminating seismic waves by correlations; however, there is a limitation on the reading time, and an additional system is needed to raise the mirror and let it fall. In addition, this type of gravimeter requires a highly stabilized laser and necessarily needs to be evacuated to ultra-high vacuum, which greatly restricts its application in submerged conditions and cannot be operated in motion or in microgravity, since the movement of the mirror would deviate from the local “vertical” reference.

CN102621590 discloses a system and a method for measuring the acceleration of gravity using fiber optic technology. The system comprises a fiber optic light source system, a Michelson interference system, a Fabry-Perot interference system, a vacuum system, and a data collection processing system. The Michelson interference system is used to measure the moving distance of a moving rectangular prism in the vacuum system, the Fabry-Perot interference system is used to monitor the output wavelength of an optical laser in real time, a high-precision time-frequency standard regulator timing system of the data collection processing system is used to record the moving time of the moving rectangular prism, a multi-channel data collection card of the data collection processing system is used to collect the position and time of the moving prism and the wavelength of the optical laser in real time, and finally, the change relation of the acceleration of gravity with time is obtained through a computing program.

In short, said data acquisition and processing system of CN102621590 comprises a high-precision frequency standard appearance timing system, high-speed multi-channel data capture card and calculation of the data acquisition process program of the value of acceleration of gravity; wherein the high-precision frequency standard appearance timing system can be used to record the running duration of the right-angle prism.

In said document CN102621590, the gravimeter is also based on a free-falling cube mirror measured by a Michelson interferometer with a fiber optic laser monitored by a Fabry-Perot interferometer via image, which acts by means of launching and falling a mirror in an evacuated region, measured by computational curve fitting.

As in document RU2193786, the disclosure reported in CN102621590 also needs a system to launch the mirror and let it fall and still needs to be operated in ultra-high vacuum and, therefore, cannot be subjected to very high pressures without having an appropriate encapsulation. In addition, it is evident that the aforementioned Chinese document is monitored by a Fabry-Perot interferometer by image, and not by frequency as in the present disclosure, with a very high uncertainty in this case.

CN104808254 discloses a multi-frequency laser interference optical system for a high-precision absolute gravity meter. The multi-frequency laser interference optical system comprises a frequency-stabilized laser, a collimating and beam-expanding mirror, an adjustable reflector, a beam splitter, a reference prism, a faller prism, a horizontal liquid level, a reflecting prism, a diaphragm, a focusing lens and a photoelectric detector, wherein the laser is emitted by the frequency-stabilized laser, after passing through the collimating and beam-expanding mirror, the beam is transmitted vertically downward, transmitted after being reflected by the adjustable reflector, and then split into a vertically downward transmitted light beam and a reference light beam transmitted horizontally to the right by the beam splitter, wherein the test light beam is shot to the horizontal liquid level after being reflected by the reference prism and the faller prism for many times, then returns according to the original light path after being reflected to join the reference light beam to generate interference fringes, and the interference fringes pass through the open diaphragm and are focused on the photoelectric detector by the focal lens.

CN104808254 discloses an absolute gravity meter adopting the system. According to the multi-frequency laser interference optical system for the high-precision absolute gravity meter and its application, the test accuracy can be improved several times, and the direction of the test light beam can be simply and effectively adjusted to ensure that the direction is parallel to the direction of the acceleration of gravity.

In the aforementioned document CN104808254, the gravimeter is based on a free-falling cube mirror measured by a Michelson interferometer with the possibility of multiple passes through the falling mirror to increase the amount of interference fringes in the falling time and consequently increase sensitivity, which also uses the mirror launching and falling in an evacuated region and proceed with the measurements by means of computational curve fitting.

In addition, there is also a need for ultra-high vacuum evacuation, which cannot be subjected to very high pressures without appropriate extra encapsulation, and it further requires the use of a container with alcohol or mercury to reflect the laser and perform the self-alignment with the vertical. This brings endless complications to this system, making it unfeasible to use outside a narrow temperature range and further requires an environment without vibration.

On the other hand, the equipment of the present disclosure can be evacuated, or filled with inert gas, or even filled with an incompressible liquid, which allows the sensor to be directly subjected to very high pressures without encapsulation.

RU2754098 is part of the space industry and refers to a device for measuring the gravitational gradient on board a spacecraft. The device contains two test masses (1, 2) with optical reflective elements of the laser beam fixed on the same in the form of a pair of corner reflectors (12-15) and a laser interferometer (5) optically connected to the same, located on one coordinate axis of the spacecraft, as well as a calculator (7). In addition, the device includes lightning arresters (3) rigidly connected to the spacecraft body for fixing and ensuring the free flight of the test masses (1, 2) inside the spacecraft, gyroscopic stabilizers (10, 11) of the position in space, a calibration mass (4), mounted on a movable carriage rigidly connected to the spacecraft body, and, among other components, a source of high stability of pulse counting in the form of a highly stable frequency standard (6). In addition, the outlet of a highly stable frequency standard (6) is connected to the laser interferometers (5) of all three gravimeters, and the outlets of the laser interferometers (5) of all gravimeters are connected to a computer (7).

RU2754098 indicates that the achieved technical effect is to ensure simultaneous measurements of three components of the gravitational gradient on board the spacecraft by increasing the measurement accuracy of the signal parameters at the outlet of the photodetector, increasing the degree of stabilization of the laser beam reflectors and increasing the path length of the working laser beam, as well as flight calibration of the device by introducing a calibration mass into the composition of the device; facilitating the placement of the instrument on board a spacecraft of complex design, avoiding obstacles for measuring the laser beam near the center of mass of the spacecraft. In this document, the gravimeter, in the form of a gradiometer (implemented by the difference in gravity between two heights; in this case, by the simultaneous fall of two mirrors that start at different heights and are thus subject to slightly different gravities, which generates a different distance between the mirrors), is also based on a Michelson interferometer. It should also be noted that this gradiometer has a specific application for space, since there may be a non-trivial difference between the release of one mass-mirror in relation to the other, this system would only work in space with very small accelerations of gravity.

In short, in addition to the common problems already mentioned above in relation to the documents of prior art, there is also the need to stabilize the laser, while in the present disclosure the laser does not need to be stabilized and the reference, by the Fabry-Perot measured in frequency, is already incorporated.

The present disclosure, by using the difference in the resonance frequency of the Fabry-Perot sensor and the reference sensor, which can be read directly in frequency by a counter/frequency meter from the radio frequencies given to the electro-optical or acousto-optic modulators, by measuring the beat frequency of two independent lasers that are close in wavelength, allowed faster and more accurate readings in relation to the gravimeters of the state of the art, which would not be obvious to a technician skilled on the subject based on the documents of prior art as listed herein, for at least one of the reasons as already listed.

### BRIEF DESCRIPTION OF THE DISCLOSURE

The equipment described herein uses lasers stabilized in the resonant optical cavities of Fabry-Perot Interferometers (FPIs), with at least one reference interferometer, in order to cancel out the effects of atmospheric variation in the measurement of the variation in gravitational acceleration. In addition, the radio frequency used in the modulators, or the frequency beat of the independent lasers, allows the measurement of the variation of “g” directly in the variable “frequency”, which allows high-precision measurements due to the existence of accurate clocks in counters/frequency meters. In short, the gravimeter comprises a high-finesse Fabry-Perot interferometer-based sensor with fast reading time, does not require high vacuum in the chamber thereof, can be operated in motion and can be subjected to very high pressures, without an extra encapsulation, and requires low electrical power for operation, and makes gravity measurements directly in frequency.

### BRIEF DESCRIPTION OF THE FIGURES

In order to obtain a total and complete visualization of the object of this disclosure, the figures to which references are made are presented, as follows.

FIG. 1 illustrates an example embodiment of a configuration of the gravimeter having a single laser and an acousto-optic modulator according to the present disclosure. Acronyms: Radio Frequency (RF); Fabry-Perot Interferometer (FPI); Acousto-Optic Modulator (AOM); Pound-Drever-Hall (PDH); Temperature controller (T_{ctrl}); Single-mode fibers (SM fibers).

FIG. 2 illustrates an alternative embodiment of a gravimeter configuration comprising single laser and electro-optical modulator according to the present disclosure. Acronyms: Radio frequency (RF); Fabry-Perot interferometer (FPI); Electro-optical modulator with single sideband without carrier (EOM CF-SSB); Pound-Drever-Hall (PDH); Temperature controller (T_{ctrl}); Single-mode fibers (SM fibers).

Figure second alternative 3 illustrates a embodiment configuration comprising two closely tuned “single-frequency” lasers, the lasers directly coupled to single-mode optical fibers and beam splitters also in fiber according to the present disclosure. Acronyms: Single-frequency laser with isolator (ECL/DBF/DBR laser); Power splitter (Split); Radio frequency (RF); Fabry-Perot interferometer (FPI); beat frequency (Beat freq.); Pound-Drever-Hall (PDH); temperature controller (T_{ctrl}); single-mode fibers (SM Fibers).

FIG. 4 illustrates a third alternative embodiment configuration, referring to a schematic diagram of a gravimeter with three axes for automatic determination of the local “vertical” and an internal and external pressure balancing system filled with fluid according to the present disclosure. Acronyms: Internal pressure (Pᵢₙₜ); External pressure (Pₑₓₜ); Fabry-Perot interferometer (FPI); temperature controller (T_{ctrl}).

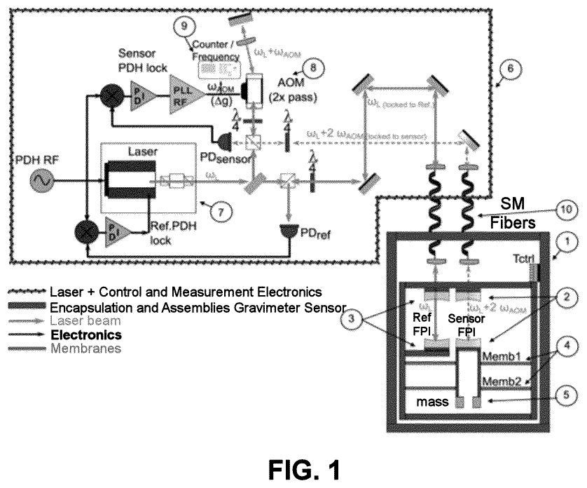

### DETAILED DESCRIPTION OF THE DISCLOSURE

The present disclosure has as its basic principle the use of lasers stabilized in resonant optical cavities of Fabry-Perot Interferometers (FPIs). At least two FPIs are always used. The reference FPI has the 2^{nd} mirror rigidly mounted, while the sensor FPI has the 2^{nd} mirror mounted on a tube (axis) with extra mass and an axial spring defined by two or more membranes that hold the tube.

The reference FPI shares the same atmospheric conditions as the sensor FPI, that is: temperature, pressure, and gas or fluid between the mirrors. This allows canceling the effects of atmospheric variation in the measurement of the variation of the gravitational acceleration and achieving long-term stability in the measurement.

The use of a single laser with the aid of optical modulators (AOM or EOM) allows the generation of a second beam with a frequency difference, each locked in one of the resonant optical cavities (Sensor and Reference), or, alternatively, the use of two independent lasers, but close in frequency, each locked in frequency to the aforementioned resonant optical cavities (Sensor and Reference).

The radio frequency used in the modulators, or the frequency beat of the independent lasers, allows the measurement of the variation of “g” directly in the variable “frequency”, which allows high-precision measurements due to the existence of accurate clocks in counters/frequency meters.

In addition, the use of an alternative configuration of three FPIs forming a tripod with the “vertical” allows finding the direction of the local \vec{g} and its vector variation in the 3 directions, but with greater precision in the vertical. This allows the sensor to be quickly used without the need for a “horizontal” base or long processes of adjusting the vertical position of the gravimeter, as is done in other types of gravimeters.

Finally, the possibility of filling the hermetic chamber of the sensors with an inert and nearly incompressible fluid and with the presence of a bellows tube for small expansion or contraction of the chamber volume allows the internal pressure to be balanced with the external pressure. This allows the chamber of the sensors to be subjected to large pressure variations and submerged to great depths.

In this way, the gravimeter described in the present disclosure comprises:
at least one encapsulation of the gravimetric sensor module (1);
a first Fabry-Perot Interferometer FPI (2), this being a sensor assembled with a second mirror in membranes and with extra mass;
a second Fabry-Perot Interferometer FPI (3) of reference, rigidly mounted in the same atmosphere as the sensor FPI and with substantially similar geometry;
at least two opposing and spaced membranes (4), defining the axis of the first Fabry-Perot Interferometer (FPI) and the axial spring, holding the geometrically adapted tube for mounting the second mirror and the extra mass of the sensor; an extra mass of the sensor (5);
at least one encapsulation of the laser system (6) with laser control and measurement electronics;
at least one laser (7), with an optical isolator and modulated by radio frequency and locked, in frequency, to the optical cavity of the reference Fabry-Perot Interferometer FPI (3);
a modulator (8), with double-pass frequency shift, for locking to the optical cavity of the sensor FPI;
at least one high-quality counter or frequency meter (9), which directly reads the radio frequency used for the modulator in frequency locking with the sensor FPI, in which its frequency reading can be calibrated directly in reading the variation of the acceleration of gravity; a plurality of optical fibers (10) that carry and bring signals from the sensor Fabry-Perot Interferometer FPI (2) and reference FPI (3) for locking the laser and modulator frequencies.

In the first configuration of the present disclosure, said modulator (8) is an Acousto-Optical modulator AOM.

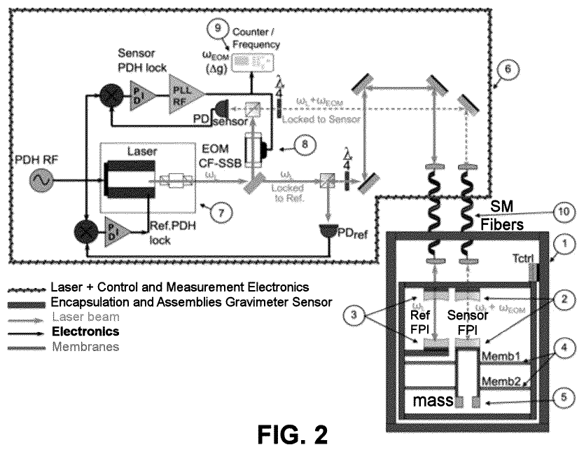

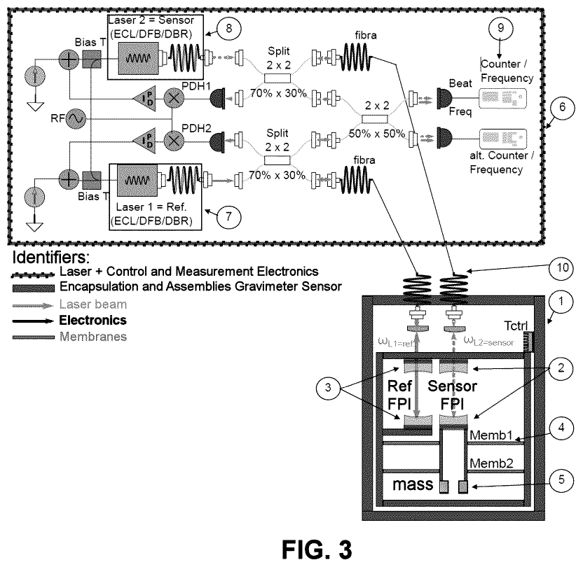

In an alternative configuration of the gravimeter of the present disclosure, the modulator is optionally an Electro-Optical (EOM-CF-SSB) modulator with single-sideband (Single-Sideband) and carrier-free (Carrier-Free) with frequency shift for locking to the optical cavity of the sensor FPI, as detailed in FIG. 2.

In a second alternative configuration, the at least one laser (7) is optionally single-frequency and of the extended cavity diode laser (ECDL) or diode laser with distributed Bragg reflection (DBR) or distributed feedback diode laser (DFB) type.

Still in the second alternative configuration, the modulator (8) is also replaced by a single-frequency laser and of the (ECDL) or diode laser with distributed Bragg reflection (DBR) or distributed feedback diode laser (DFB) type, also with an optical isolator and modulated by radio frequency and locked, in frequency, to the optical cavity of the sensor Fabry-Perot Interferometer FPI (2). In this case, the at least one high-quality counter or frequency meter (9) directly reads the radio frequency generated by the frequency beat between the two said lasers.

Finally, in the second alternative configuration, the plurality of optical fibers that carry and bring signals from the sensor Fabry-Perot Interferometer FPI (2) and reference FPI (3) lock the frequencies of at least two lasers (7) (8).

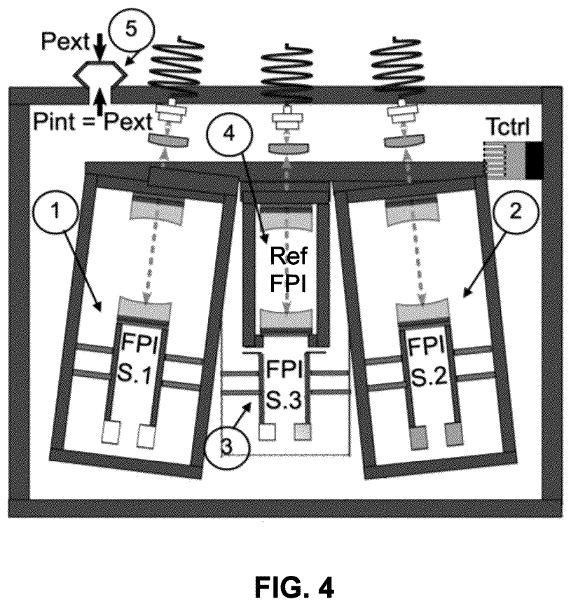

In a third alternative configuration, said gravimeter may be a three-axis gravimeter for automatic determination of the local vertical comprising a fluid-filled internal and external pressure balancing system, as can be seen in FIG. 4, which details only the chamber comprising the sensors.

In this third configuration, the lasers may be generated as in FIG. 2, by separating the laser into 4 beams and using 3 EOM modulators, or as in FIG. 3, by using 4 independent lasers.

In the third configuration, three sensor Fabry-Perot interferometers (FPIs) are symmetrically mounted at an angle) (˜15° with respect to the vertical in a “tripod” shape, with the reference FPI (4) vertically positioned. It should be inferred from the two-dimensional exploration of FIG. 4 that the FPIs (1) and (2) come with their axis out of the image plane, as well as going to the left and right, respectively, while FPI (3) enters with its axis inside the plane.

In the third configuration, the reference Fabry-Perot Interferometer (FPI) has the second mirror rigidly mounted and in the same atmosphere and distance between mirrors as the other sensor FPIs.

In the third configuration, the gravimeter of the present disclosure additionally comprises at least one bellows tube (5) that allows a small expansion or compression of the internal space filled with fluid (almost incompressible) achieving the balance between the internal and external pressure.

The fluid in question is appropriately chosen to have little chemical influence on the sensor elements and little variation in refractive index with temperature and pressure. This system allows the hermetic chamber to be subjected to high pressure variations and the system to be submerged to great depths.

In this way, it is reiterated that the present disclosure was able to promote long-term stability by incorporating a reference interferometer within the same hermetic environment filled with noble gas (or inert fluid) and stabilized in temperature-without the use of the spring (membrane)—thus providing a local reference for calibration and compensation of environmental effects (refraction index of the medium and temperature).

It is further understood that the main difference of the present disclosure is based on the measurement of gravity directly in frequency, using the locking of a laser beam to the reference interferometer and another beam (a) of the same laser—or (b) of a second laser of close frequency—to the sensor interferometer by means of electro-optical or acousto-optic modulators, and the difference in the resonance frequencies of the sensor Fabry-Perot and the reference Fabry-Perot can be read directly in frequency by a counter/frequency meter from the radio frequencies given to the electro-optical or acousto-optic modulators in case (a) or, in case (b), by measuring the beat frequency of the two independent lasers, but close in wavelength.

The variation in the local acceleration of gravity (or inertial acceleration) translates into a variation in this frequency difference between the sensor and reference interferometers. Reading directly in frequency allows for fast or high-precision readings, given that frequency is the variable that allows for the most accurate measurement with excellent references from quartz clocks, controlled by GPS, or atomic clocks that even exist in the form of chips. The temporal variation of the measured frequency translates into acceleration variation by applying calibration factors.

The use of the present disclosure further allows for the calibration of the sensor sensitivity in relation to the local “g” by rotating the sensor axis around the vertical. Since the sensor is mostly uniaxial, by rotating the sensor in a controlled manner around the vertical, the calibration of frequency variation is obtained as a fraction of the local gravitational acceleration (g), the value of which can be absolutely calibrated by the concomitant use and in the same location of an absolute gravimeter. In this calibration, the “Cosine” function is mechanically performed in relation to the vertical axis with many decimal places.

The gravimeter described herein further allows for the possibility of self-determination of the local “vertical” by using three sensor interferometers, instead of just one, forming a triangle at angles typically of 15°, for example. In addition to the identical construction, the interferometers are initially calibrated, making the set rotate around the vertical for each of the axes. With this option, after this calibration is performed in the laboratory, the vertical can be self-determined in the field use of the sensor.

In one embodiment, the gravimeter is configured as a compact and hermetic sensor, whose laser beams and power for temperature control can be brought by a power umbilical and single-mode optical fibers or even in a configuration that incorporates compact lasers and control, measurement, and communication electronics. This hermetic sensor, under inert gas or fluid, can be lowered into drills or even be submersible.

The gravimeter is further configured in one embodiment as a compact and hermetic sensor containing inert fluid, which practically does not react with the materials involved in the sensor, and whose refractive index is weakly dependent on temperature and pressure, and which fills the entire volume of the sensor and which, with a small appendage with a bellows tube, allows the sensor to automatically equalize its internal pressure to the external pressure. Such a construction allows the sensor to withstand extreme pressures such as that of the ocean floor without the need to be enclosed in high-pressure structures.

The present disclosure, in any of its configurations, can be used for gravitational mapping on board drones, robots, cars, trucks, ships or submarines, providing auxiliary maps in the prospecting of oil & gas fields, aquifers, mineral reserves, and other natural geological or geographical features constructed by humans or animals. In these moving cases, the sensitivity will be limited by the inertial acceleration noise added by the transport, and which can be treated a posteriori with averages by long-term integration or elimination of bands of frequencies.

In stationary applications, they can monitor temporal variations in aquifers, reservoirs, oil and gas fields, Earth tides, and seismic waves.

Because they are compact, robust, highly sensitive, consume low powers without requiring ultra-high vacuum (as in the case of absolute sensors using falling cube mirrors or atomic interferometry) or cryostats (as in the case of high-sensitivity superconducting relative sensors), and can be submerged, a network of these sensors can be taken relatively close to wells for real-time and long-term monitoring of the oil and gas extraction or liquid injection.

Because they are compact, robust, and economical, they can find applications in monitoring the level of waterlogging of slopes or dams in the prevention of disasters in risk areas.

Because they are compact, robust and can self-determine the local “vertical”, in the third alternative configuration, they can be quickly installed and operated in locations without a “horizontal” base and ready for measurement without the necessary care with alignment with the local “vertical” like most other sensors.

Because they are robust, compact, highly sensitive, consume low powers without requiring ultra-high vacuum (as in the case of absolute sensors using falling cube mirrors or atomic interferometry) or cryostats (as in the case of high-sensitivity superconducting relative sensors), they can be taken on space missions in spacecraft, satellites, space stations, and used in lunar or Mars rovers to search for underground aquifers, for example.

Those skilled in the art will appreciate the knowledge presented herein and will be able to reproduce the disclosure in the presented embodiments and in other variants, encompassed by the scope of the attached claims.

1. An optical gravimeter comprising:
at least one encapsulation of a gravimetric sensor module;
a first Fabry-Perot Interferometer (FPI) configured as a sensor mounted FPI having a mirror on membranes;
a second reference FPI rigidly mounted in the same atmosphere as the sensor mounted FPI;
at least two opposed and spaced membranes, defining the axis of the first FPI and of the axial spring, to hold a tube and geometrically adapted for mounting the mirror and an extra mass of the sensor mounted FPI;
an extra mass of a sensor;
at least one encapsulation of a laser system having laser control and measurement electronics;
at least one laser having an optical isolator and modulated by radio frequency and locked, in frequency, to the optical cavity of a reference FPI;
a modulator having double-pass frequency shift locked to the optical cavity of the sensor FPI;
at least one counter or frequency meter, directly reading the radio frequency of the modulator in frequency locking with the sensor FPI; and
a plurality of optical fibers to lock the frequencies of the laser and the modulator.

2. The optical gravimeter according to claim 1, wherein the frequency is calibrated directly by variation of acceleration of gravity.

3. The optical gravimeter according to claim 1, wherein the modulator comprises an Acousto-Optical Modulator (AOM).

4. The optical gravimeter according to claim 1, wherein the modulator comprises an Electro-Optical Modulator (EOM-CF-SSB).

5. The optical gravimeter according to claim 4, wherein the EOM-CF-SSB includes a single sideband and carrier suppression, with frequency shift for locking to the optical cavity of the sensor FPI.

6. The optical gravimeter according to claim 1, wherein the at least one laser comprises a single frequency and one or more of the extended cavity diode laser (ECDL), diode laser with distributed Bragg reflection (DBR), or distributed feedback diode laser (DFB) type.

7. The optical gravimeter according to claim 1, wherein the modulator is replaced by a single frequency laser and one or more of the extended cavity diode laser (ECDL), diode laser with distributed Bragg reflection (DBR), or distributed feedback diode laser (DFB) type.

8. The optical gravimeter according to claim 7, wherein when the modulator is replaced by a single frequency laser, and wherein at least one counter or frequency meter directly reads radio frequency generated by the frequency beat between two lasers.

9. The optical gravimeter according to claim 1, wherein the plurality of optical fibers locks the frequencies of at least two lasers.

10. The optical gravimeter according to claim 1, wherein the optical gravimeter includes three axes for automatic determination of the local vertical comprising a fluid-filled internal and external pressure balancing system.

11. The optical gravimeter according to claim 1, wherein three sensor FPIs are symmetrically mounted at an angle) (˜15°) with respect to a vertical, while a reference FPI is vertical.

12. The optical gravimeter according to claim 1, wherein the reference FPI has the mirror rigidly mounted and in the same atmosphere and distance between mirrors as the three sensor FPIs.

13. The optical gravimeter according to claim 1, further comprising at least one bellows tube that allows small expansion or compression of the internal space filled with fluid.
